(19) United States
(12) Patent Application Publication
(10) Pub. No.: US 2025/0233120 A1
(43) Pub. Date: Jul. 17, 2025

(54) METHODS FOR ADDING CATHODE ELECTROLYTE INTERFACE-ENHANCING ADDITIVES TO IMPROVE CYCLING STABILITY OF CATHODE ELECTRODES

(71) Applicant: GM GLOBAL TECHNOLOGY OPERATIONS LLC, Detroit, MI (US)

(72) Inventors: Raneen TAHA, Sterling Heights, MI (US); Vamakshi YADAV, Sterling Heights, MI (US); Chuanlong WANG, Troy, MI (US); Gongshin QI, Troy, MI (US); Yuntao GU, Farmington Hills, MI (US); Lei WANG, Rochester Hills, MI (US)

(21) Appl. No.: 18/410,221

(22) Filed: Jan. 11, 2024

(51) Int. Cl. H01M 4/04; H01M 4/505; H01M 4/525; H01M 10/0567; H01M 10/0569

(52) U.S. Cl. CPC H01M 4/0404; H01M 4/0471; H01M 4/505; H01M 4/525; H01M 10/0567; H01M 10/0569; H01M 2300/0028

(57) ABSTRACT

A method for manufacturing a cathode electrode for a battery cell includes mixing a cathode active material, a conductive filler, a binder, a solvent, and a cathode electrolyte interface (CEI)-enhancing additive to form a slurry mixture; and casting the slurry mixture onto a cathode current collector to form a cathode active material layer of a cathode electrode.

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to cathode electrodes for battery cells, and more particularly methods for adding cathode electrolyte interface-enhancing additives during manufacturing of the cathode electrode to improve cycling stability.

The present disclosure relates to battery cells, and more particularly to battery cells including cathode electrodes including lithium- and manganese-rich cathode active material and fluorinated electrolyte.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, and separators. The cathode electrodes include a cathode active material layer arranged on a cathode current collector. The anode electrodes include an anode active material layer arranged on an anode current collector.

### SUMMARY

A method for manufacturing a cathode electrode for a battery cell includes mixing a cathode active material, a conductive filler, a binder, a solvent, and a cathode electrolyte interface (CEI)-enhancing additive to form a slurry mixture; and casting the slurry mixture onto a cathode current collector to form a cathode active material layer of a cathode electrode.

In some examples, the CEI-enhancing additive is selected from a group consisting of lithium difluorophosphate (LiPO₂F₂), lithium hexafluorophosphate (LiPF₆), lithium fluoride (LiF), lithium phosphate (Li₃PO₄), lithium difluoro (oxalato) borate (LiDFOB), lithium difluorosulfimide (LiFSl), lithium bis (trifluoromethanesulfonyl)imide (LiTFSl), and combinations thereof.

In some examples, the CEI-enhancing additive includes lithium difluorophosphate (LiPO₂F₂).

In some examples, the method includes drying the cathode electrode in an oven; calendaring the cathode electrode; arranging the cathode electrode in a stack; arranging the stack in a battery cell enclosure; and adding electrolyte to the battery cell enclosure.

In some examples, the electrolyte comprises a carbonate-based electrolyte. The electrolyte comprises a mixture of FEC and DEC. The electrolyte further includes the CEI-enhancing electrolyte.

In some examples, the cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof. The CEI-enhancing additive comprises 0.25 wt % to 5 wt % and the cathode active material comprises 95 wt % to 99.75 wt %. The CEI-enhancing additive comprises 0.25 wt % to 2 wt % and the cathode active material comprises 98 wt % to 99.75 wt %.

A method for manufacturing a cathode electrode for a battery cell includes mixing a cathode active material, a conductive filler, a binder, and a solvent to form a slurry mixture; casting the slurry mixture onto a cathode current collector to form a cathode active material layer of the cathode electrode; and one of ball milling and spray dry coating a cathode electrolyte interface (CEI)-enhancing additive onto the cathode active material layer.

In other features, the CEI-enhancing additive is selected from a group consisting of lithium difluorophosphate (LiPO₂F₂), lithium hexafluorophosphate (LiPF₆), lithium fluoride (LiF), lithium phosphate (Li₃PO₄), lithium difluoro (oxalato) borate (LiDFOB), lithium difluorosulfimide (LiFSl), lithium bis (trifluoromethanesulfonyl)imide (LiTFSl), and combinations thereof. The cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof.

In other features, the method includes drying the cathode electrode in an oven; calendaring the cathode electrode; arranging the cathode electrode in a stack; arranging the stack in a battery cell enclosure; and adding electrolyte to the battery cell enclosure.

In other features, the electrolyte also includes the CEI-enhancing electrolyte. The CEI-enhancing additive comprises 0.25 wt % to 5 wt % and the cathode active material comprises 95 wt % to 99.75 wt %.

A method for manufacturing a cathode electrode for a battery cell includes mixing a cathode active material, a conductive filler, a binder, and a solvent, to form a slurry mixture; casting the slurry mixture onto a cathode current collector to form a cathode active material layer of the cathode electrode; drying the cathode electrode in an oven; calendaring the cathode electrode; and dipping the cathode electrode in a bath including a cathode electrolyte interface (CEI)-enhancing additive and solvent.

In other features, the CEI-enhancing additive is selected from a group consisting of lithium difluorophosphate (LiPO₂F₂), lithium hexafluorophosphate (LiPF₆), lithium fluoride (LiF), lithium phosphate (Li₃PO₄), lithium difluoro (oxalato) borate (LiDFOB), lithium difluorosulfimide (LiFSl), lithium bis (trifluoromethanesulfonyl)imide (LiTFSl), and combinations thereof. The cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof.

In other features, the method includes arranging the cathode electrode in a stack; arranging the stack in a battery cell enclosure; and adding electrolyte to the battery cell enclosure. The electrolyte also includes the CEI-enhancing electrolyte. The CEI-enhancing additive comprises 0.25 wt % to 5 wt % and the cathode active material comprises 95 wt % to 99.75 wt %.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross section of an example of a battery cell including cathode electrodes, anode electrodes, and separators according to the present disclosure;

FIG. 2 is a side cross section of an example of a cathode electrode including a CEI-enhancing additive according to the present disclosure;

FIG. 3 is a flowchart of an example of a method for manufacturing cathode electrodes using a slurry mixture including a cathode electrolyte interface-enhancing additive according to the present disclosure;

FIG. 4 is a flowchart of an example of a method for manufacturing cathode electrodes including spreading a cathode electrolyte interface-enhancing additive onto a cathode active material layer using ball milling or spray dry coating according to the present disclosure;

FIG. 5 is a flowchart of an example of a method for dipping a cathode electrode into a bath including a cathode electrolyte interface-enhancing additive according to the present disclosure;

FIGS. 6 and 7 are graphs illustrating discharge capacity retention percentage and discharge capacity, respectively, as a function of cycles for different concentrations of CEI-enhancing additive added to a slurry mixture according to the present disclosure; and

FIG. 8 is a graph illustrating discharge capacity and discharge capacity retention percentage, respectively, as a function of cycles for a first battery cell including CEI-enhancing additive added to the electrolyte and a second battery cell including CEI-enhancing additive added to the slurry according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

During battery cell fabrication, some cathode-electrolyte interface (CEI) issues can be mitigated by creating artificial barriers or coatings on the particles of the cathode active material. In some battery cells, the formation of stable cathode-electrolyte interfaces (CEI) is facilitated by adding CEI-enhancing additives to the electrolyte after the battery cell is manufactured. The CEI-enhancing additives mixed with the electrolyte form the coating on the cathode active material. For example, the coating can include lithium fluoride (LiF) and/or lithium phosphate (Li₃PO₄) species.

In some examples, a precursor such as lithium difluorophosphate (LiPO₂F₂) is added to the electrolyte to form the LiF and Li₃PO₄ coating on the cathode active material. The limited solubility of the CEI-enhancing additives (e.g., LiPO₂F₂) in some electrolyte systems (e.g., carbonate-based electrolyte, fluoroethylene carbonate (FEC): diethyl carbonate (DEC) solvent systems) poses a challenge. For example, adding the CEI-enhancing additive to FEC: DEC solvent systems produces concentrations up to around 1 wt % of the cathode active material layer. However, higher concentrations are desired. Adding more CEI-enhancing additive to the electrolyte does not increase the concentration of the CEI-enhancing additive on the cathode active material or improve the stability of the CEI.

The present disclosure relates to methods for adding the CEI-enhancing additive to the cathode active material layer during manufacturing as a replacement for or a supplement to adding the CEI-enhancing additive to the electrolyte. In some examples, the method for manufacturing the cathode electrode according to the present disclosure includes adding the CEI-enhancing additive (e.g., LiPO₂F₂) to a slurry mixture for a cathode active material layer during the fabrication process. Using this approach promotes the formation of a robust CEI, thereby enhancing the stability and performance of the CEI. In some examples, the CEI-enhancing additive is also added to the electrolyte.

In other examples, ball milling or spray dry coating are used to spread the CEI-enhancing additive onto the cathode active material layer during manufacturing. In still other examples, the cathode electrode is manufactured and calendared without the CEI-enhancing additive. Then, the electrode is dipped into a bath including a mixture of the CEI-enhancing additive and solvent to coat the cathode electrode. The cathode electrode is dried in an oven to remove the solvent. In some examples, the process can be complimentary to other additives added to the electrolyte.

Referring now to FIG. 1, a battery cell 10 includes C cathode electrodes 20, A anode electrodes 40, and S separators 32 arranged in a predetermined sequence in a battery cell stack 12, where C, S and A are integers greater than zero. The battery cell stack 12 is arranged in an enclosure 50. Electrolyte 52 is added to the enclosure 50 as will be described further below. In some examples, the electrolyte optionally includes the CEI-enhancing additive and/or other additives. The C cathode electrodes 20-1, 20-2, . . . , and 20-C include cathode active material layers 24 arranged on one or both sides of a cathode current collector 26.

During charging/discharging, the A anode electrodes 40 and the C cathode electrodes 20 exchange lithium ions. The A anode electrodes 40-1, 40-2, . . . , and 40-A include anode active material layers 42 arranged on one or both sides of the anode current collectors 46. In some examples, the cathode active material layers 24 and/or the anode active material layers 42 comprise coatings including one or more active materials, one or more conductive additives, and/or one or more binder materials that are applied to the current collectors.

In some examples, the cathode current collector 26 and/or the anode current collector 46 comprise metal foil, metal mesh, perforated metal, 3 dimensional (3D) metal foam, and/or expanded metal. In some examples, the current collectors are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or different sides of the battery cell stack 12. The external tabs 28 and 48 are connected to terminals of the battery cells.

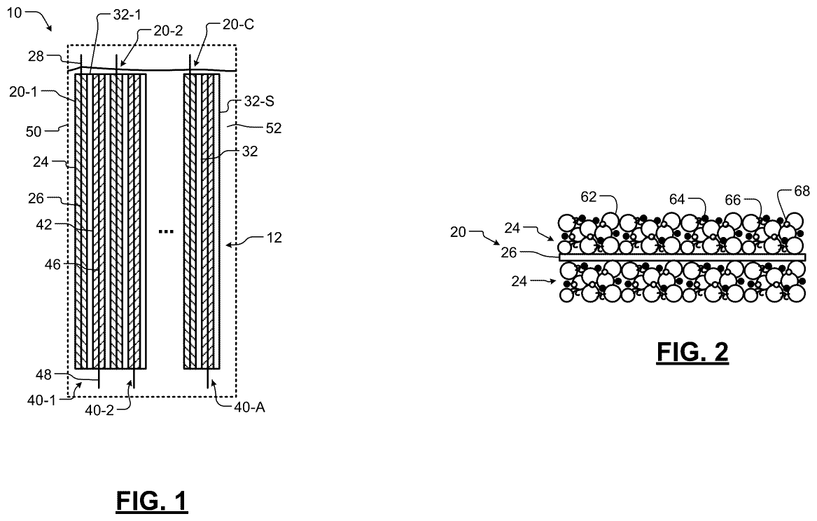

Referring now to FIG. 2, one of the C cathode electrodes 20 is shown in further detail. The cathode active material layer 24 of the C cathode electrodes 20 includes cathode active material 62, a conductive additive 64, and a binder 66.

As described above, the CEI-enhancing additive can be added to the slurry (e.g., as shown at 68) forming the cathode active material layer 24, spread onto the cathode electrode using ball milling or spray dry coating, or the cathode electrode can be dip coated in a mixture of the CEI-enhancing additive and solvent. In some examples, the CEI-enhancing additive is selected from a group consisting of lithium difluorophosphate (LiPO₂F₂), lithium hexafluorophosphate (LiPF₆), lithium fluoride (LiF), lithium phosphate (Li₃PO₄), lithium difluoro (oxalato) borate (LiDFOB), lithium difluorosulfimide (LiFSl), lithium bis(trifluoromethanesulfonyl)imide (LiTFSl), and combinations thereof.

In some examples, the cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof.

In some examples, the CEI-enhancing additive comprises 0.25 wt % to 5.0 wt % of the cathode active material. In some examples, the CEI-enhancing additive comprises 0.25 wt % to 2.0 wt % of the cathode active material. In some examples, the CEI-enhancing additive comprises 1.0 wt % to 2.0 wt % of the cathode active material. In some examples, the CEI-enhancing additive is added during manufacturing and to the electrolyte (e.g., 0 wt % to 1.0 wt % CEI-enhancing additive).

In some examples, the CEI-enhancing additive is added directly to the slurry including cathode active material, conductive filler, binder, and solvent (e.g., NMP). In other examples, the cathode electrode is cast onto the current collector and then the CEI-enhancing additive is ball milled or spray dry coated onto the cathode active material layer. In some examples, the cathode electrodes are manufactured and then dipped into a bath including a CEI-enhancing additive and solvent (such as LiPO₂F₂). The cathode electrodes are dried in an oven to evaporate the solvent.

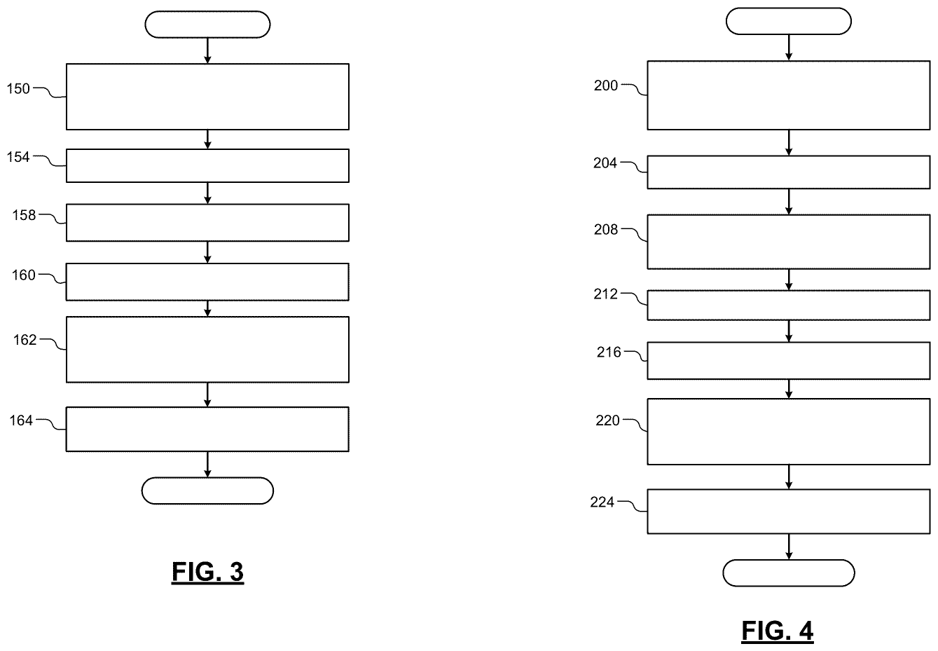

Referring now to FIG. 3, a method for manufacturing cathode electrodes includes adding one or more CEI-enhancing additives to a slurry mixture and casting the slurry mixture onto a cathode current collector. At 150, a cathode active material, a conductive filler, a binder, and a solvent are mixed to form a slurry mixture. The one or more CEI-enhancing additives are added to the slurry mixture. At 154, the slurry mixture is cast onto a cathode current collector. At 158, the cathode electrodes are dried in an oven to remove the solvent.

At 160, the cathode electrodes are calendared using one or more pairs of rollers that press and/or heat the cathode electrodes. Additional processing (e.g., cutting or stamping of individual cathode electrodes, forming external tabs, etc.) is performed. At 162, the cathode electrodes, anode electrodes, and separators are arranged in a stack, interconnected, and/or arranged in a battery cell enclosure. At 164, the liquid electrolyte is added to the battery cell. In some examples, the electrolyte optionally also includes the CEI-enhancing additive to supplement the CEI-enhancing additive added in step 150.

Referring now to FIG. 4, a method for manufacturing cathode electrodes includes ball milling or spray dry coating the CEI-enhancing additive onto the cathode electrode. At 200, a cathode active material, a conductive filler, a binder, and a solvent are mixed into a slurry mixture. At 204, the slurry mixture is cast onto a cathode current collector. At 208, ball milling or stray dry coating is used to spread one or more CEI-enhancing additives onto the cathode active material layer.

At 212, the cathode electrodes are dried in an oven to remove the solvent. At 216, the cathode electrodes are calendared using one or more pairs of rollers that press and/or heat the cathode electrodes. Additional processing (e.g., cutting or stamping of individual cathode electrodes, forming external tabs, etc.) is performed. At 220, the cathode electrodes, anode electrodes, and separators are arranged in a stack, interconnected, and arranged in a battery cell enclosure. At 224, the liquid electrolyte is added to the battery cell. In some examples, the electrolyte also optionally includes the CEI-enhancing additive to supplement the CEI-enhancing additive added in step 208.

Referring now to FIG. 5, a method for manufacturing cathode electrodes includes dipping the cathode electrodes into a bath including one or more cathode electrolyte interface-enhancing additives and a solvent. At 250, a cathode active material, a conductive filler, a binder, and a solvent are mixed into a slurry mixture. At 254, the slurry mixture is cast onto a cathode current collector. At 260, the cathode electrode is dipped into a bath including the one or more CEI-enhancing additives and the solvent. At 264, the cathode electrodes are dried in an oven to remove the solvent. At 268, the cathode electrodes are calendared using one or more pairs of rollers that press and/or heat the cathode electrodes. Additional processing (e.g., cutting or stamping of individual cathode electrodes, forming external tabs, etc.) is performed. At 272, the cathode electrodes, anode electrodes, and separators are stacked, interconnected, and arranged in a battery cell enclosure. At 274, the liquid electrolyte is added to the battery cell. In some examples, the electrolyte also optionally includes the CEI-enhancing additive to supplement the CEI-enhancing added in step 270.

The methods for adding the CEI-enhancing additives during manufacturing instead of or in addition to adding the CEI-enhancing additive to the electrolyte can be used to optimize the CEI to improve cycling stability with little or no capacity loss. The amount of the CEI-enhancing additive that is added is not limited by its solubility in the electrolyte solvent system. The methods described herein achieve uniform additive distribution across the cathode active material layer by adding the CEI-enhancing additive during manufacturing of the cathode electrode.

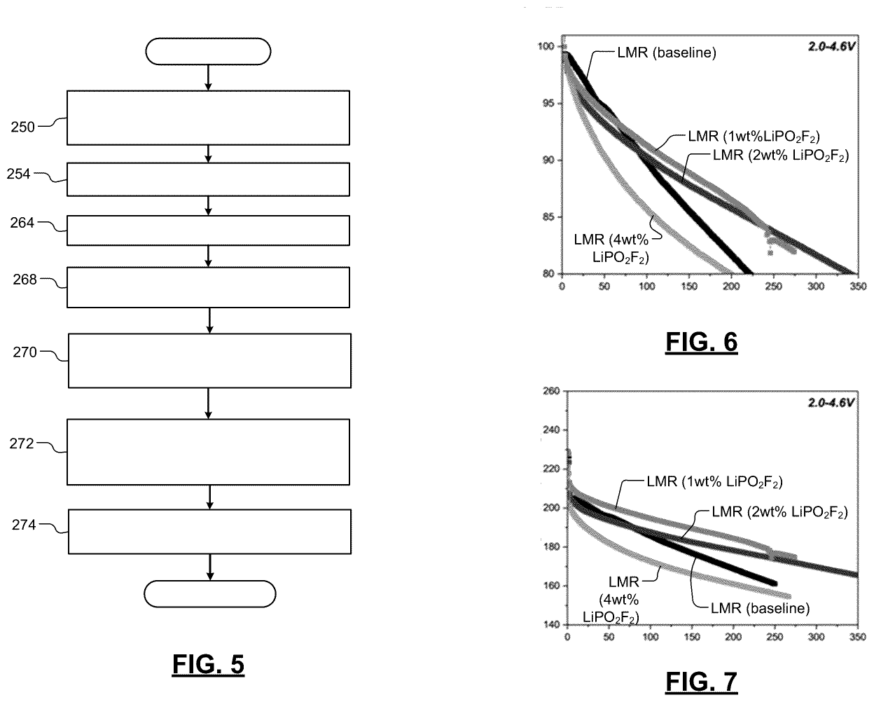

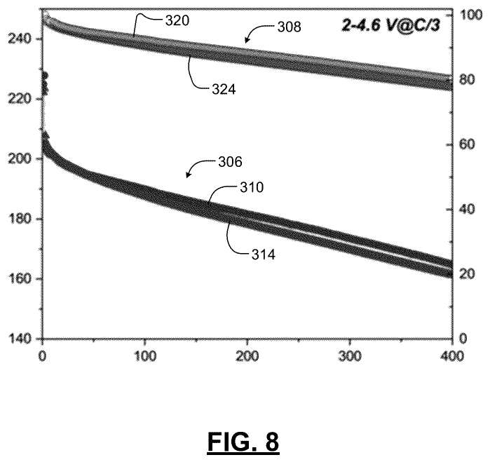

Referring now to FIGS. 6 and 7, discharge capacity retention percentage and discharge capacity, respectively, are shown as a function of cycles for different concentrations of CEI-enhancing additive. In this example, coin battery cells include cathode active material including lithium- and manganese-rich (LMR) cathode active material with a porosity of 30%. The anode included 5.5% wt SiOx/graphite and a 30% porosity. The electrolyte includes 50 μL of FEC: DEC at a ratio of 1:4. The coin battery cell has a positive capacity of ˜5 mAh/cm₂ and a negative capacity of ˜5.5 mAh/cm². Active mass loading on the cathode electrode was 20-21 mg/cm². The battery cells were subjected to formation and a life cycle protocol. Formation was performed for 2 cycles with continuous current charging (CCC) at C/20 to 4.6V and continuous voltage charging (CVC) at 4.6V until C/50. The life cycle protocol included charging CCC at C/3 to 4.6V, CVC at 4.6V to C/20, and discharge at continuous current (CC) at C/3 to 2.0V. In this example, 2 wt % LiPO₂F₂ provided higher discharge capacity retention percentage over a higher number of cycles.

Referring now to FIG. 8, discharge capacity and discharge capacity retention percentage, respectively, are shown as a function of cycles for the coin battery cells of FIGS. 6 and 7. The graph compares discharge capacity at 306 and discharge capacity retention percentage at 308 for a first battery cell (including LMR active material DEC01 and 1 wt % LiPO₂F₂ added to the electrolyte) and a second battery cell (including LMR active material and 2 wt % LiPO₂F₂ with DECO1 added to slurry).

Discharge capacity and discharge capacity retention percentage for the first battery cell are shown at 310 and 320, respectively. Discharge capacity and discharge capacity retention percentage for the second battery cell are shown at 314 and 324, respectively. Adding LiPO₂F₂ to either the slurry mixture or the electrolyte shows similar capacity and cycling performance. Therefore, slurry addition can be used as a method to prepare battery cells with optimal amount of CEI-enhancing additive (e.g., LiPO₂F₂).

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing a cathode electrode for a battery cell, comprising:
mixing a cathode active material, a conductive filler, a binder, a solvent, and a cathode electrolyte interface (CEI)-enhancing additive to form a slurry mixture; and
casting the slurry mixture onto a cathode current collector to form a cathode active material layer of a cathode electrode.

2. The method of claim 1, wherein the CEI-enhancing additive is selected from a group consisting of lithium difluorophosphate (LiPO₂F₂), lithium hexafluorophosphate (LiPF₆), lithium fluoride (LiF), lithium phosphate (Li₃PO₄), lithium difluoro (oxalato) borate (LiDFOB), lithium difluorosulfimide (LiFSl), lithium bis (trifluoromethanesulfonyl)imide (LiTFSl), and combinations thereof.

3. The method of claim 1, wherein the CEI-enhancing additive includes lithium difluorophosphate (LiPO₂F₂).

4. The method of claim 1, further comprising:
drying the cathode electrode in an oven;
calendaring the cathode electrode;
arranging the cathode electrode in a stack;
arranging the stack in a battery cell enclosure; and
adding electrolyte to the battery cell enclosure.

5. The method of claim 4, wherein the electrolyte comprises a carbonate-based electrolyte.

6. The method of claim 4, wherein the electrolyte comprises a mixture of FEC and DEC.

7. The method of claim 4, wherein the electrolyte further includes the CEI-enhancing additive.

8. The method of claim 1, wherein the cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof.

9. The method of claim 1, wherein the CEI-enhancing additive comprises 0.25 wt % to 5 wt % and the cathode active material comprises 95 wt % to 99.75 wt %.

10. The method of claim 1, wherein the CEI-enhancing additive comprises 0.25 wt % to 2 wt % and the cathode active material comprises 98 wt % to 99.75 wt %.

11. A method for manufacturing a cathode electrode for a battery cell, comprising:
mixing a cathode active material, a conductive filler, a binder, and a solvent to form a slurry mixture;
casting the slurry mixture onto a cathode current collector to form a cathode active material layer of the cathode electrode; and
applying a cathode electrolyte interface (CEI)-enhancing additive onto the cathode active material layer.

12. The method of claim 11, wherein the cathode electrolyte interface (CEI)-enhancing additive is applied by ball milling a cathode electrolyte interface (CEI)-enhancing additive onto the cathode active material layer.

13. The method of claim 11, wherein the cathode electrolyte interface (CEI)-enhancing additive is applied by spray dry coating the cathode electrolyte interface (CEI)-enhancing additive onto the cathode active material layer.

14. The method of claim 11, wherein the cathode electrolyte interface (CEI)-enhancing additive is applied by drying the cathode electrode in an oven, calendaring the cathode electrode, and dipping the cathode electrode in a bath including a cathode electrolyte interface (CEI)-enhancing additive and solvent.

15. The method of claim 11, wherein:
the CEI-enhancing additive is selected from a group consisting of lithium difluorophosphate (LiPO₂F₂), lithium hexafluorophosphate (LiPF₆), lithium fluoride (LiF), lithium phosphate (Li₃PO₄), lithium difluoro (oxalato) borate (LiDFOB), lithium difluorosulfimide (LiFSl), lithium bis(trifluoromethanesulfonyl)imide (LiTFSl), and combinations thereof, and
the cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof.

16. The method of claim 11, further comprising:
drying the cathode electrode in an oven;
calendaring the cathode electrode;
arranging the cathode electrode in a stack;
arranging the stack in a battery cell enclosure; and
adding electrolyte to the battery cell enclosure,
wherein the electrolyte includes the CEI-enhancing additive.

17. The method of claim 11, wherein the CEI-enhancing additive comprises 0.25 wt % to 5 wt % and the cathode active material comprises 95 wt % to 99.75 wt %.

18. A slurry mixture for a cathode electrode of a battery cell, comprising:
a cathode active material;
a conductive filler;
a binder;
a solvent; and
a cathode electrolyte interface (CEI)-enhancing additive and solvent,
wherein the CEI-enhancing additive comprises lithium difluorophosphate (LiPO₂F₂).

19. The slurry mixture of claim 18, wherein the cathode active material is selected from a group consisting of lithium- and manganese-rich cathode material (LMR), lithium nickel cobalt manganese aluminum (NCMA), lithium nickel manganese cobalt (NMC), lithium manganese oxide (LMO), lithium nickel oxide (LNO), lithium iron phosphate (LFP), lithium manganese iron phosphate (LMFP), and combinations thereof.

20. The slurry mixture of claim 18, wherein the CEI-enhancing additive comprises 0.25 wt % to 5 wt % and the cathode active material comprises 95 wt % to 99.75 wt %.
